(19) United States
(12) Patent Application Publication
(10) Pub. No.: US 2025/0199127 A1
(43) Pub. Date: Jun. 19, 2025

(54) LIDAR AND DESIGN METHOD OF SAME

(71) Applicant: BEIJING MORELITE SEMICONDUCTOR CO., LTD., Beijing (CN)

(72) Inventors: Yunsong WANG, Beijing (CN); Guomin JIANG, Beijing (CN); Tianbo SUN, Beijing (CN)

(21) Appl. No.: 19/072,100

(22) Filed: Mar. 6, 2025

Related U.S. Application Data
(63) Continuation of application No. PCT/CN2023/116941, filed on Sep. 5, 2023.

(30) Foreign Application Priority Data
Sep. 9, 2022 (CN) 202211099391.8

(51) Int. Cl. G01S 7/481

(52) U.S. Cl. CPC G01S 7/4814; G01S 7/4817

(57) ABSTRACT

A LiDAR system and a design method of the LiDAR system are provided. The LiDAR system includes: optical channels configured to emit light beams; a collimating lens, provided on one side, in a light exit direction, of the optical channels and configured to perform collimation operation on the light beams; and a dispersion element, provided on a side, away from the optical channels, of the collimating lens; wherein the light beams respectively generate outgoing light beams after passing through the dispersion element, wherein the wavelength of each light beam in the light beams is tunable, so that the outgoing light beam corresponding to each light beam performs light beam scanning, and scanning angle ranges of the outgoing light beams corresponding to the light beams are sequentially adjacent and are basically not overlapped.

### CROSS-REFERENCE TO RELATED APPLICATION

This application is a continuation of a PCT application No. PCT/CN2023/116941 filed on Sep. 5, 2023, which claims the priority of Chinese patent application No. 202211099391.8 entitled “LIDAR AND DESIGN METHOD OF SAME” filed before CNIPA on Sep. 9, 2022, the disclosure of which is hereby incorporated by reference in its entirety.

### TECHNICAL FIELD

This application relates to the technical field of a LiDAR (Light Detection And Ranging) system, and in particular, to a LiDAR system and a design method of the same.

### BACKGROUND

LiDAR (Light Laser Detection and Ranging) is simply referred to as a laser detection and ranging system, which is a radar using a laser as a radiation source. The LiDAR system is a product that combines laser technology and radar technology, and includes at least a transmitter and a receiver.

### SUMMARY OF THE INVENTION

A Light Detection And Ranging (LiDAR) system is provided in some embodiments of the present application. The LiDAR system includes: a plurality of optical channels configured to emit a plurality of light beams; a collimating lens disposed on one side, in light emitting directions, of the plurality of optical channels and configured to perform a collimating operation on the plurality of light beams; and a dispersion element disposed on a side, away from the plurality of optical channels, of the collimating lens, wherein the plurality of light beams respectively generate a plurality of emergent light beams after passing through the dispersion element, wherein a wavelength of each light beam in the plurality of light beams is tunable, so that an emergent light beam corresponding to the each light beam performs light beam scanning, and a scanning angle range of each of the plurality of emergent light beams corresponding to the plurality of light beams is sequentially adjacent and substantially non-overlapping.

In some embodiments, the LiDAR system further includes: a tunable laser source configured to emit a laser with a tunable wavelength; and an optical splitter configured to receive the laser and be connected to the plurality of optical channels, and configured to split the laser into the plurality of light beams, and transmit the plurality of light beams to the plurality of optical channels respectively.

In some embodiments, the dispersion element includes a diffraction grating.

In some embodiments, the scanning angle range of an emergent light beam corresponding to any of the plurality of light beams is determined by a deflection angle of the emergent light beam corresponding to the light beam in a wavelength tuning process, and the deflection angle θ of the emergent light beam corresponding to the light beam is determined by a following formula:

$${θ}_{deflect} = Δ θ + {θ}_{m} = Δ θ + asin ( - \frac{λ}{d} + sin ( {θ}_{i} ) )$$

$${θ}_{i} = Δ θ - θ = Δθ - atan ( \frac{h}{f} )$$

wherein θ is an included angle between the light beam having passed through the collimating lens and an optical axis of the collimating lens, h is a distance between the optical channel corresponding to the light beam and the optical axis of the collimating lens, f is a focal length of the collimating lens, Δθ is an angle between the optical axis of the collimating lens and the normal line of the diffraction grating, θi is an incident angle when the light beam is incident to the diffraction grating, λ is a wavelength of the light beam, d is a grating constant of the diffraction grating, and θm is an exit angle, from the diffraction grating, of the emergent light beam corresponding to the light beam.

In some embodiments, a wavelength tuning width is 40 nm.

In some embodiments, a scanning included angle of beam scanning performed by an emergent light beam corresponding to each light beam is in a range of 3° to 7°.

In some embodiments, the LiDAR system further includes: a rotating mirror configured to reflect the plurality of emergent light beams to realize beam surface scanning.

In some embodiments, a rotating shaft of the rotating mirror is coplanar with the plurality of emergent light beams.

In some embodiments, the plurality of optical channels are arranged in parallel.

A design method of a LiDAR system is provided in some embodiments of the present disclosure, wherein the LiDAR system includes the LiDAR system provided above, the method includes: determining a correspondence between a position of an optical channel of the plurality of optical channels and a scanning angle range based on parameters of the collimating lens and the dispersion element, based on positional relationship between the collimating lens and the dispersion element, and based on a beam wavelength tuning range; and dynamically tuning positions of the plurality of optical channels based on the correspondence, so that scanning angle ranges of the emergent light beams corresponding to the plurality of light beams are adjacent and spliced with each other, to match a preset overall included angle of light beam scanning.

Compared with the related art, the foregoing solutions of the embodiments of the present application have at least the following technical effects: the plurality of light beams using the plurality of optical channels synchronously pass through the collimating lens and the dispersion element, and the beam scanning is realized through wavelength tuning, and the scanning areas executed by the emergent light beams corresponding to the plurality of light beams are sequentially adjacent and do not overlap basically, so that a relatively large scanning area can be quickly obtained by tuning a smaller wavelength range.

### BRIEF DESCRIPTION OF THE DRAWINGS

The accompanying drawings, which are incorporated in and constitute a part of this specification, illustrate embodiments consistent with the present disclosure and, together with the description, serve to explain the principles of the present disclosure. Obviously, the accompanying drawings in the following description are merely some embodiments of the present application, and for a person of ordinary skill in the art, other drawings may be obtained based on these accompanying drawings without creative efforts. In the drawings:

FIG. 1 is a schematic structural diagram of a LiDAR system in the related art;

FIG. 2 is a schematic structural diagram of a LiDAR system according to some embodiments of the present application;

FIG. 3 is a diagram of a correspondence between a deflection angle and a wavelength of an emergent light beam corresponding to each light beam provided by some embodiments of the present application;

FIG. 4 is a schematic structural diagram of a LiDAR system according to some embodiments of the present application;

FIG. 5 is a design method of a LiDAR system according to some embodiments of the present application.

### DETAILED DESCRIPTION

In order to make the objectives, technical solutions, and advantages of the present application clearer, the following further describes the present application in detail with reference to the accompanying drawings. Obviously, the described embodiments are only part of, rather than all, of the embodiments of the present application. All other embodiments obtained by a person of ordinary skill in the art based on the embodiments of the present application without creative efforts shall therefore fall within the protection scope of the present application.

The terms used in the embodiments of the present disclosure are merely for the purpose of describing particular embodiments and are not intended to limit the present disclosure. As used in the embodiments of the present application and the appended claims, the singular forms “a,” “an,” and “the” are intended to include plural forms unless the context clearly indicates otherwise; “a plurality of” generally includes at least two.

It should be understood that the term “and/or” used in this specification describes an association relationship between associated objects, indicating that there may be three relationships: for example, A and/or B may indicate that A exists alone, A and B exist simultaneously, or B exists alone. In addition, the character “/” in this specification generally indicates an “or” relationship between the associated objects.

It should be understood that although terms such as “first,” “second,” and “third” may be used in the embodiments of the present application to describe elements, these terms should not limit the elements. These terms are only used to distinguish between different elements. For example, without departing from the scope of the embodiments of the present application, a “first element” may also be referred to as a “second element,” and similarly, a “second element” may also be referred to as a “first element.”

It should also be noted that the terms “comprising,” “including,” or any other variation thereof are intended to cover non-exclusive inclusion, such that a product or apparatus comprising a series of elements includes not only those elements but may also include other elements not explicitly listed or inherent elements of the product or apparatus. Without further limitations, an element defined by the phrase “comprising a . . . ” does not preclude the existence of additional identical elements in the product or apparatus that includes the element.

In the related art, light beam scanning of the LiDAR system may be implemented by tuning a wavelength. As shown in FIG. 1, an existing LiDAR system includes a tunable laser source 1, a collimating lens 2, and a diffraction grating 3, wherein a light beam generated by the tunable laser source 1 is collimated by the collimating lens 2 and incident on the diffraction grating 3, and the diffraction grating 3 deflects the light beam. The tunable wavelength range of the light beam emitted by the tunable laser source 1 is, for example, 1460 nm to 1620 nm, i.e., the wavelength tuning width is 160 nm. Due to the astigmatism characteristics of the diffraction grating 3, by gradually increasing or decreasing the wavelength within the range of 1460 nm to 1620 nm, the deflection angle α of the light beam gradually changes after passing through the diffraction grating. As shown in FIG. 1, when the tunable wavelength of the light beam emitted by the tunable laser source 1 gradually increases from 1460 nm to 1620 nm, the deflection angle α of the light beam gradually increases. Therefore, beam scanning of the LiDAR system is realized, and the scanning angle of the beam is, for example, the change value of the deflection angle α of the light beam, such as 25°. In the related art, the tunable laser source needs a long time to tune the wavelength within the range of 1460 nm to 1620 nm, which is not conducive to the fast scanning requirement of the LiDAR system. Additionally, the tuning range of a conventional tunable laser is only 40 nm, and the cost of the tunable laser rapidly increases with the expansion of the tuning range, making it unsuitable for LiDAR system products.

To overcome the above problems, the present application provides a LiDAR system including: a plurality of optical channels configured to emit a plurality of light beams, wherein the light beams have the same wavelength; a collimating lens disposed on one side of the plurality of optical channels in the light-emitting direction, and configured to collimate the plurality of light beams; and a dispersion element disposed on a side of the collimating lens away from the plurality of optical channels. The plurality of light beams generate a plurality of emergent light beams after passing through the dispersion element, wherein the wavelength of each light beam is tunable such that the emergent light beam corresponding each light beam performs beam scanning. The scanning angle ranges of the emergent light beams corresponding to the plurality of light beams are sequentially adjacent and do not substantially overlap. By synchronously enabling the plurality of light beams to path through the collimating lens and the dispersion element, beam scanning is realized through wavelength tuning. The scanning areas of the emergent light beams are sequentially adjacent and non-overlapping, enabling the splicing to from a larger scanning area. Moreover, a larger scanning area can be rapidly obtained by tuning a smaller wavelength range.

The following describes optional embodiments of the present application in detail with reference to the accompanying drawings.

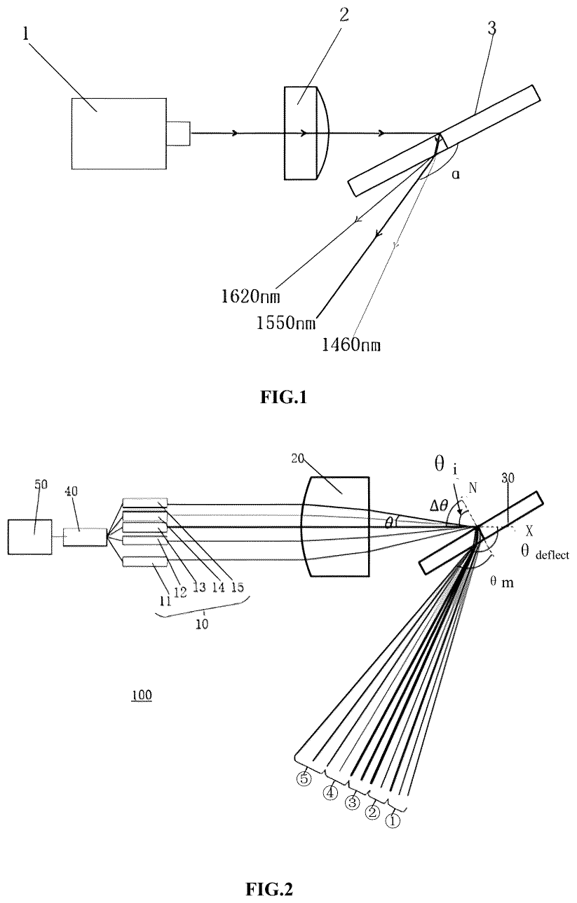

FIG. 2 is a schematic structural diagram of a LiDAR system according to some embodiments of the present application, where the LiDAR system 100 includes a plurality of optical channels 10, a collimating lens 20, and a dispersion element 30.

The plurality of optical channels 10 are configured to emit a plurality of light beams, the plurality of light beams have the same wavelength, in some embodiments, the phases of the plurality of light beams may also be the same, and the plurality of light beams may be obtained by splitting the same light beam. The number of the plurality of optical channels 10 is, for example, two or more, for example, 4 or 5.

The collimating lens 20 is disposed on one side of the light emitting direction of the plurality of optical channels 10, and is configured to perform a collimation operation on the plurality of light beams. A light beam emitted from any optical channel 10 may have a certain diffusion angle, and each light beam needs to be collimated by using the collimating lens 20.

The dispersion element 30 is disposed on a side of the collimating lens 20 away from the plurality of optical channels 10, and the plurality of light beams respectively generate a plurality of emergent light beams after passing through the dispersion element 30. The wavelength of each of the plurality of light beams is tunable, so that the emergent light beam corresponding to each light beam implements light beam scanning, and the scanning angle ranges of the emergent light beams corresponding to the plurality of light beams are sequentially adjacent and substantially do not overlap.

The LiDAR system 100 provided in this embodiment may implement light beam scanning through wavelength tuning, the emergent light beams corresponding to the plurality of light beams simultaneously perform scanning of the corresponding scanning angle range, and the scanning areas of the emergent light beams corresponding to the plurality of light beams are sequentially adjacent to each other and are basically not overlapped, so that the whole scanning area can be spliced, and a larger scanning area can be quickly obtained by tuning smaller wavelength ranges. The wavelength tuning width is small, and the tuning can be completed within a short period of time, which can basically meet the requirement of LiDAR system for fast beam scanning.

In some embodiments, as shown in FIG. 2, the LiDAR system 100 further includes a tunable laser source 40 and an optical splitter 50.

The tunable laser source 40 is configured to emit a laser with an tunable wavelength, the wavelength of the laser may be tunable between 1530 nm and 1570 nm, and the wavelength tuning width is 40 nm.

The optical splitter 50 receives the laser, is connected to the plurality of optical channels 10, and is configured to split the laser into a plurality of light beams, and transmit the plurality of light beams to the plurality of optical channels 10 respectively, so that the wavelengths of the plurality of light beams output by the plurality of optical channels 10 may be synchronously tuned.

In some embodiments, the dispersion element 30 includes a diffraction grating, the diffraction grating has a dispersion property, and when the wavelength of the same beam is tuned, the emergent beam emitted by the dispersion element 30 corresponding to the beam performs beam scanning, and the range width of the scanning angle range is, for example, 3° to 7°.

In some embodiments, the scanning angle range of the emergent light beam corresponding to any light beam is determined by the deflection angle of the emergent light beam corresponding to the light beam in the wavelength tuning process, and the deflection angle θ of the emergent light beam corresponding to the light beam is determined by the following formula:

$${θ}_{deflect} = Δ θ + {θ}_{m} = Δ θ + asin ( - \frac{λ}{d} + sin ( {θ}_{i} ) )$$

$${θ}_{i} = Δ θ - θ = Δθ - atan ( \frac{h}{f} )$$

where θ is the included angle between the beam having passed through the collimating lens and the optical axis of the collimating lens, h is the distance between the optical channel corresponding to the beam and the optical axis of the collimating lens, f is the focal length of the collimating lens, Δθ is the angle between the optical axis of the collimating lens and the normal of the diffraction grating, θi is the incident angle when the beam is incident to the diffraction grating, λ is the wavelength of the beam, d is the grating constant of the diffraction grating, and θm is the exit angle, from the diffraction grating, of the emergent beam corresponding to the beam.

As shown in FIG. 2, only the parameters corresponding to the uppermost optical channel are marked, and a person skilled in the art may correspondingly determine the positions corresponding to the parameters corresponding to the other optical channels. In the above formula, as shown in FIG. 2, when the optical channel is located above the optical axis X of the collimating lens 20, h is a positive value, and when the optical channel is located below the optical axis of the collimating lens, h is a negative value.

Specifically, when the beam scanning of the LiDAR system is performed by tuning the wavelengths of the light beams, for example, the wavelengths of the plurality of light beams may be adjusted between λ1 and λ2; for any light beam, when the wavelength λ of the light beam is λ1, it is determined that the deflection angle θ_{deflect} of the emergent light beam corresponding to the light beam is θ_{deflect1}; when the wavelength λ of the light beam is λ2, it is determined that the deflection angle θ_{deflect} of the emergent light beam corresponding to the light beam is θ_{deflect2}. The scanning angle range of the emergent light beam corresponding to the light beam is θ_{deflect1} to θ_{deflect2}, and the range width of the scanning angle range is θ_{deflect2}−θ_{deflect1}.

In some embodiments, the wavelength of each light beam may be tunable between 1530 nm and 1570 nm, and the wavelength tuning width is 40 nm.

In some embodiments, a scanning included angle of beam scanning performed by the emergent light beam corresponding to each light beam is 3° to 7°.

The following describes the embodiments in detail by taking the number of the plurality of optical channels 10 being 5 as an example, the focal length f of the collimating lens 20 is, for example, 10.2 mm, and the included angle 40 between the optical axis X of the collimating lens and the normal N of the diffraction grating is, for example, 60°. As shown in FIG. 2, the plurality of optical channels 10 include a first optical channel 11, a second optical channel 12, a third optical channel 13, a fourth optical channel 14, and a fifth optical channel 15, which are arranged in parallel sequentially. For example, the wavelength λ of each light beam emitted by each optical channel may be tunable between 1530 nm and 1570 nm, the wavelength tuning width is 40 nm, and for a tunable laser source, the tuning of the wavelength tuning width of 40 nm may be completed in a shorter time period, which may substantially conform to the fast scanning requirement of the LiDAR system on the light beam.

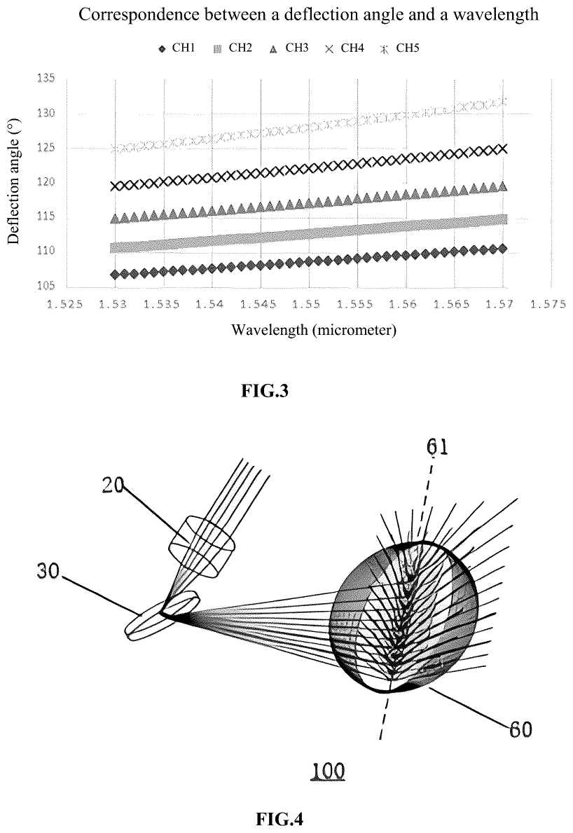

FIG. 3 is a diagram showing a correspondence between the deflection angle of the emergent light beam and the wavelength of the light beam provided in some embodiments of the present application. In FIG. 3, the first optical channel 11, the second optical channel 12, the third optical channel 13, the fourth optical channel 14, and the fifth optical channel 15 respectively represent the first optical channel 11, the second optical channel 12, the third optical channel 13, the fourth optical channel 14, and the fifth optical channel 15. As shown in FIG. 2 and FIG. 3, the distance between the first optical channel 11 and the optical axis X of the collimating lens 20 is −2.32 mm, and when the wavelength is tunable between 1530 nm and 1570 nm, the first scanning angle range corresponding to the first light beam L11 output by the first optical channel 11 (labeled by \textcircled{1} in FIG. 2) is 106°-110°, and the width of the first scanning angle range is 4°. The distance between the second optical channel 12 and the optical axis X of the collimating lens 20 is −1 mm, and when the wavelength is tunable between 1530 nm and 1570 nm, the second scanning angle range corresponding to the second light beam L12 output by the second optical channel 12 (labeled by \textcircled{2} in FIG. 2) is 110°-115°, and the width of the second scanning angle range is 5°. The distance between the third optical channel 13 and the optical axis X of the collimating lens 20 is 0 mm, and when the wavelength is tunable between 1530 nm and 1570 nm, the third scanning angle range corresponding to the third light beam L13 output by the third optical channel 13 (labeled by 3 in FIG. 2) is 115°-120°, and the width of the third scanning angle range is 5°. The distance between the fourth optical channel 14 and the optical axis X of the collimating lens 20 is 0.84 mm, and when the wavelength is tunable between 1530 nm and 1570 nm, the fourth scanning angle range corresponding to the fourth light beam L14 output by the fourth optical channel 14 (labeled by 4) in FIG. 2) is 120°-125°, and the width of the fourth scanning angle range is 5°. The distance between the fifth optical channel 15 and the optical axis X of the collimating lens 20 is 1.6 mm, and when the wavelength is tunable between 1530 nm and 1570 nm, the fifth scanning angle range corresponding to the fifth light beam L15 output by the fifth optical channel 15 (labeled by 5) in FIG. 2) is 125°-131°, and the width of the fifth scanning angle range is 6°. When the wavelengths of the light beams are adjusted, the output beams corresponding to the first to fifth beams synchronously perform beam scanning, so that the overall beam scanning angle range is 106° to 131°, and the range width of the overall scanning angle range is 25°, that is, the beam scanning angle range is 25°. In this way, by using a small range of laser wavelength tuning, a larger angle range of beam scanning is achieved, the laser wavelength is tuned within a small range, rapid scanning of the light beam is achieved, and the light beam scanning speed of the LiDAR system is improved.

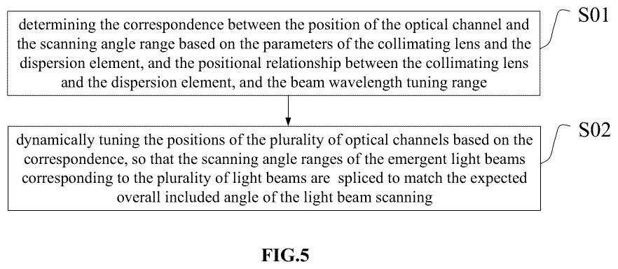

FIG. 4 is a schematic structural diagram of a LiDAR system according to some embodiments of the present application. An optical channel, a tunable laser source, and an optical splitter are not shown in FIG. 4. As shown in FIG. 4, the LiDAR system 100 may further include a rotating mirror 60, and the rotating mirror 60 is configured to reflect a plurality of emergent light beams to implement beam surface scanning.

In some embodiments, a rotating shaft 61 of the rotating mirror 60 is coplanar with the plurality of emergent light beams, and the plurality of emergent light beams may be placed in another dimension, through rotation of the rotating mirror 60, to perform scanning. The beam surface scanning is realized by tuning the rotation of the rotating mirror 60 and by tuning the laser wavelength in the LiDAR system 100.

In some embodiments, as shown in FIG. 2 to FIG. 4, the plurality of optical channels 10 are arranged in parallel. The plurality of light beams emitted by the plurality of optical channels 10 are approximately parallel as much as possible, so that they can be substantially incident into a relatively small area on the dispersion element after passing through the collimating lens 20, so that the beam scanning generated by the LiDAR system has a better form.

FIG. 5 is a design method of a LiDAR system according to some embodiments of the present application. As shown in FIG. 5, the design method includes the following steps S01 to S03.

S01: determining the correspondence between the position of the optical channel and the scanning angle range based on the parameters of the collimating lens and the dispersion element, and the positional relationship between the collimating lens and the dispersion element, and the beam wavelength tuning range.

Specifically, according to the parameters of the collimating lens, for example, a focal length f, a size, and the like, the dispersion element is, for example, a diffraction grating, a parameter of the diffraction grating is, for example, a grating constant d, a size, and the like, and the positional relationship between the collimating lens and the dispersion element (the diffraction grating) is, for example, an included angle Δθ between an optical axis of the collimating lens and a normal line of the diffraction grating. The beam wavelength tuning range is, for example, 1530 nm to 1570 nm, and the width of the wavelength tuning range is, for example, 40 nm. The correspondence between the position of the optical channel and the scanning angle range may be determined according to the data and the formula involved in the foregoing embodiments. The position of the optical channel is characterized by the distance between the optical channel and the optical axis of the collimating lens. For each position, a scan angle range corresponding to the position may be determined.

S02: dynamically tuning the positions of the plurality of optical channels based on the correspondence, so that the scanning angle ranges of the emergent light beams corresponding to the plurality of light beams are adjacently spliced to match the preset overall included angle of the light beam scanning.

Specifically, the position of the first optical channel may be selected first, and based on the correspondence between the position of the optical channel and the scanning angle range, the position of the second optical channel and/or the third optical channel adjacent to the first optical channel is matched and determined, so that the scanning angle ranges corresponding to the second optical channel and/or the third optical channel are adjacent to but not substantially overlapped with the corresponding scanning angle range of the first optical channel, and the second optical channel and the third optical channel are respectively located on two sides of the first optical channel. Then, based on the correspondence between the position of the optical channel and the scanning angle range, the position of the fourth optical channel position adjacent to the second optical channel is matched and determined, so that the scanning angle range corresponding to the fourth optical channel is adjacent to but basically not overlapped with the corresponding scanning angle range of the second optical channel, the fourth optical channel and the first optical channel are located on the two sides of the second optical channel respectively. The scanning angle range corresponding to the fifth optical channel is adjacent to but basically not overlapped with the corresponding scanning angle range of the third optical channel, and the fifth optical channel and the first optical channel are located on the two sides of the third optical channel respectively. Then, the position of the newly added optical channel is continuously matched and determined based on the correspondence between the position of the optical channel and the scanning angle range, and so on, until the range width of the overall scanning angle range formed after the scanning angle ranges of the emergent light beams corresponding to the plurality of optical channels are spliced is substantially equal to the preset included angle of the beam scanning.

In some embodiments, the positions of the plurality of determined optical channels may also be dynamically adjusted, so that the range width of the overall scanning angle range formed after the scanning angle ranges of the emergent light beams corresponding to the plurality of optical channels are spliced is closer to the preset beam-scanning included angle.

In this specification, various parts are described in a manner of combining parallel and progressive, each part focuses on a difference from other parts, and the same or similar parts among the parts may be obtained by referring to each other.

With regard to the above description of the embodiments of the present disclosure, the features described in the embodiments of the present disclosure may be replaced or combined with each other, so that those skilled in the art can implement or use the present disclosure. Various modifications to these embodiments will be apparent to those skilled in the art, and the general principles defined herein may be implemented in other embodiments without departing from the spirit or scope of the present disclosure. Thus, the present disclosure will not be limited to the embodiments shown herein but is to be accorded the widest scope consistent with the principles and novel features disclosed herein.

Finally, it should be noted that the embodiments in this specification are described by way of example, each embodiment focuses on differences from other embodiments, and the same or similar parts between the embodiments may be obtained by referring to each other. For the system or device disclosed in the embodiments, since it corresponds to the method disclosed in the embodiments, the description is relatively simple, and for the relevant parts between the method and the device or system, reference may be made to the description of the part of the method embodiments.

The above embodiments are merely illustrative of the technical solutions of the present application and do not limit the scope of the present application. Although this application has been described in detail with reference to the aforementioned embodiments, those skilled in the art should understand that various modifications may be made to the technical solutions described in the embodiments, or equivalent substitutions may be made for some technical features therein, and such modifications or substitutions do not depart from the spirit and scope of the technical solutions described in each embodiment of the present application.

What is claimed is:

1. A Light Detection And Ranging (LiDAR) system, comprising:
a plurality of optical channels configured to emit a plurality of light beams;
a collimating lens disposed on one side, in light emitting directions, of the plurality of optical channels and configured to perform a collimating operation on the plurality of light beams; and
a dispersion element disposed on a side, away from the plurality of optical channels, of the collimating lens, wherein the plurality of light beams respectively generate a plurality of emergent light beams after passing through the dispersion element,
wherein a wavelength of each light beam in the plurality of light beams is tunable, so that an emergent light beam corresponding to the each light beam performs light beam scanning, and a scanning angle range of each of the plurality of emergent light beams corresponding to the plurality of light beams is sequentially adjacent and substantially non-overlapping.

2. The LiDAR system according to claim 1, further comprising:
a tunable laser source configured to emit a laser with a tunable wavelength; and
an optical splitter configured to receive the laser and be connected to the plurality of optical channels, and configured to split the laser into the plurality of light beams, and transmit the plurality of light beams to the plurality of optical channels respectively.

3. The LiDAR system according to claim 1, wherein the dispersion element comprises a diffraction grating.

4. The LiDAR system according to claim 3, wherein the scanning angle range of an emergent light beam corresponding to any of the plurality of light beams is determined by a deflection angle of the emergent light beam corresponding to the light beam in a wavelength tuning process, and the deflection angle θ of the emergent light beam corresponding to the light beam is determined by a following formula:
$${θ}_{deflect} = Δ θ + {θ}_{m} = Δ θ + asin ( - \frac{λ}{d} + sin ( {θ}_{i} ) )$$
$${θ}_{i} = Δ θ - θ = Δθ - atan ( \frac{h}{f} )$$
wherein θ is an included angle between the light beam having passed through the collimating lens and an optical axis of the collimating lens, h is a distance between the optical channel corresponding to the light beam and the optical axis of the collimating lens, f is a focal length of the collimating lens, Δθ is an angle between the optical axis of the collimating lens and the normal line of the diffraction grating, θi is an incident angle when the light beam is incident to the diffraction grating, λ is a wavelength of the light beam, d is a grating constant of the diffraction grating, and θm is an exit angle, from the diffraction grating, of the emergent light beam corresponding to the light beam.

5. The LiDAR system according to claim 1, wherein a wavelength tuning width is 40 nm.

6. The LiDAR system according to claim 5, wherein a scanning included angle of beam scanning performed by an emergent light beam corresponding to each light beam is in a range of 3° to 7°.

7. The LiDAR system according to claim 1, further comprising:
a rotating mirror configured to reflect the plurality of emergent light beams to realize beam surface scanning.

8. The LiDAR system according to claim 7, wherein a rotating shaft of the rotating mirror is coplanar with the plurality of emergent light beams.

9. The LiDAR system according to claim 1, wherein the plurality of optical channels are arranged in parallel.

10. A design method of a Light Detection And Ranging (LiDAR) system, wherein the LiDAR system comprises: a plurality of optical channels configured to emit a plurality of light beams; a collimating lens disposed on one side, in light emitting directions, of the plurality of optical channels and configured to perform a collimating operation on the plurality of light beams; and a dispersion element disposed on a side, away from the plurality of optical channels, of the collimating lens, wherein the plurality of light beams respectively generate a plurality of emergent light beams after passing through the dispersion element, wherein a wavelength of each light beam in the plurality of light beams is tunable, so that an emergent light beam corresponding to the each light beam performs light beam scanning, and a scanning angle range of each of the plurality of emergent light beams corresponding to the plurality of light beams is sequentially adjacent and substantially non-overlapping,
the method comprises:
determining a correspondence between a position of an optical channel of the plurality of optical channels and a scanning angle range based on parameters of the collimating lens and the dispersion element, based on positional relationship between the collimating lens and the dispersion element, and based on a beam wavelength tuning range; and
dynamically tuning positions of the plurality of optical channels based on the correspondence, so that scanning angle ranges of the emergent light beams corresponding to the plurality of light beams are adjacent and spliced with each other, to match a preset overall included angle of light beam scanning.

11. The design method according to claim 10, wherein the LiDAR system further comprises:
a tunable laser source configured to emit a laser with a tunable wavelength; and
an optical splitter configured to receive the laser and be connected to the plurality of optical channels, and configured to split the laser into the plurality of light beams, and transmit the plurality of light beams to the plurality of optical channels respectively.

12. The design method according to claim 10, wherein the dispersion element comprises a diffraction grating.

13. The design method according to claim 12, wherein the scanning angle range of an emergent light beam corresponding to any of the plurality of light beams is determined by a deflection angle of the emergent light beam corresponding to the light beam in a wavelength tuning process, and the deflection angle θ of the emergent light beam corresponding to the light beam is determined by a following formula:
$${θ}_{deflect} = Δ θ + {θ}_{m} = Δ θ + asin ( - \frac{λ}{d} + sin ( {θ}_{i} ) )$$
$${θ}_{i} = Δ θ - θ = Δθ - atan ( \frac{h}{f} )$$
wherein θ is an included angle between the light beam having passed through the collimating lens and an optical axis of the collimating lens, h is a distance between the optical channel corresponding to the light beam and the optical axis of the collimating lens, f is a focal length of the collimating lens, Δθ is an angle between the optical axis of the collimating lens and the normal line of the diffraction grating, θi is an incident angle when the light beam is incident to the diffraction grating, λ is a wavelength of the light beam, d is a grating constant of the diffraction grating, and θm is an exit angle, from the diffraction grating, of the emergent light beam corresponding to the light beam.

14. The design method according to claim 10, wherein wavelength tuning width is 40 nm.

15. The design method according to claim 14, wherein a scanning included angle of beam scanning performed by an emergent light beam corresponding to each light beam is in a range of 3° to 7°.

16. The design method according to claim 10, wherein the LiDAR system further comprises:
a rotating mirror configured to reflect the plurality of emergent light beams to realize beam surface scanning.

17. The design method according to claim 16, wherein a rotating shaft of the rotating mirror is coplanar with the plurality of emergent light beams.

18. The design method according to claim 10, wherein the plurality of optical channels are arranged in parallel.
